(19) United States
(12) Patent Application Publication
(10) Pub. No.: US 2020/0188821 A1
(43) Pub. Date: Jun. 18, 2020

(54) METHOD AND TOOL FOR EXTRACTING A FILTER ELEMENT FROM A PIPELINE

(71) Applicant: GEDORE WERKZEUGFABRIK GMBH & CO, KG, REMSCHEID (DE)

(72) Inventors: Florian Muenster, Duesseldorf (DE); Volker Knak, Essen (DE)

(21) Appl. No.: 16/472,869

(22) PCT Filed: Dec. 22, 2017
(86) PCT No.: PCT/EP2017/084315

§ 371 Date: Jun. 22, 2019

(30) Foreign Application Priority Data
Dec. 23, 2016 (EP) 16206644.3

(51) Int. Cl. B01D 29/96; B01D 29/58

(52) U.S. Cl. CPC B01D 29/96; B01D 2201/4038; B01D 2201/24; B01D 29/58

(57) ABSTRACT

The invention relates to a method for uninstalling a filter element from a pipeline, said filter element having a substantially central opening and an outer contour that substantially corresponds to an inner contour of said pipeline, wherein: a tool is inserted into said substantially central filter element opening, which opening runs in the longitudinal axial direction of said filter element, said tool is subsequently enlarged in at least one subsection of its peripheral surface in an extension running substantially perpendicularly to the longitudinal axial direction of the filter element, and is force and/or form-fittingly connected to an inner lateral surface of the substantially central filter element opening, said filter element finally being pushed with the tool in the longitudinal axial direction until the filter element projects out of the pipeline and is removed from the pipeline.

The invention relates to a method for uninstalling a filter element from a pipeline, wherein the filter element has a substantially central opening and an outer contour which substantially corresponds to an inner contour of the pipeline, wherein a tool is inserted into the substantially central opening of the filter element, which opening runs in longitudinal axial direction of the filter element. Furthermore, the invention relates to a tool for uninstalling a filter element from a pipeline, wherein the filter element comprises a particularly central opening and an outer contour which substantially corresponds to an inner contour of the pipeline.

For instance in re-osmosis or reverse osmosis, a medium, in which the concentration of a particular substance is to be decreased, is separated by a semipermeable membrane from the medium in which the concentration is to be increased. The latter is exposed to a pressure which must be higher than the pressure generated by the osmotic desire to balance the concentration. Such methods are used, for instance, in drinking-water treatment or in service-water treatment, but also in the military field and in space aviation. The same applies with respect to sea water desalination. For this purpose, also large-scale plants are used which consist of a multitude of pipelines in which individual filter elements are inserted which need to be replaced from time to time. A pipeline used for this purpose is of hollow cylindrical shape and provided with a multitude of filters arranged in series, the external diameters of which substantially correspond to the internal diameter of the pipeline. The filter elements consist of a filter cloth which is arranged in a wound manner and forms a cylindrical filter body. On the front face side, the filter elements comprise two retaining elements which are formed in a dimensionally stable manner. The retaining elements are formed with an outer ring which is connected via radial webs with an inner ring, defining a central opening. The outer ring has an external diameter which essentially corresponds to the internal diameter of the pipeline.

The osmosis is carried out via the filter body by pressing the medium to be purified, in particular water, through the semipermeable membrane of the filter body. The membranes operate like microscopic colanders and allow exclusively the molecules of the medium to diffuse across the membrane, wherein other components, such as salt, minerals, or other impurities, for instance bacteria and viruses, are prevented from passing through the membrane. These impurities in the medium are then removed. This is carried out in that the medium with the impurities is guided over the outer surface of the filter elements into the central area of the filter elements, whereby the purified medium, for instance water, is discharged via the central opening. The impurities then remain in the filter material of the filter element, so that a regular replacement of the filter elements is required upon saturation of the filter material.

This replacement proves to be complicated in particular with regard to uninstalling the filter elements in long pipelines. Since the external diameter of the filter elements substantially corresponds to the internal diameter of the pipelines, strong friction forces between the outer lateral surface of the filter elements and the inner lateral surface of the pipelines occur already when the filter elements are installed. This will be even increased during dismounting, e.g. due to swelling of the filter material, or due to the fact that small spaces between the retaining elements and the inner lateral surface of the pipeline are closed by impurities, so that the filter elements are sometimes stuck to the inner lateral surface of the pipeline.

Moreover, it is problematic to uninstall the filter elements which are arranged centrally in a long pipeline, since they cannot be reached without a tool. Therefore, according to the prior art, these filter elements are removed in such a way that a person assigned with uninstalling the filter elements threads a tool, for instance a metal rod with a cranked tip, into the central opening of the filter element and then pulls the filter element out of the pipeline by means of the rod. In this process, usually the retaining elements on the front face side of the filter elements are damaged or destroyed, so that subsequently, the filter elements cannot be used any more. This is significant regarding the expensive filter elements and permanently increases the operating costs of a corresponding osmosis plant.

Also pushing out the filter element is not possible without difficulty. In particular the strong friction between the filter elements and the inner wall of the pipeline require the application of a high thrust force, which, however, may also cause the filter elements to be damaged by compression.

The foregoing explanations regarding the osmosis plants described by way of example are not final. The problems described above rather also apply to other plants where the filter elements are arranged in series in pipelines. Also the dismounting of individual filter elements from a pipeline may be complicated due to the problems mentioned above.

Starting from this state of the art, it is the object of the invention to provide a method and a tool for uninstalling a filter element from a pipeline, by which the filter element can be uninstalled in a simple and, in particular with respect to the filter element and the pipeline, careful manner, by which damage to or destruction of the filter element is to be prevented in the first place.

On the part of the method according to the invention, it is provided for the solution of this problem that a tool is inserted into the substantially central opening of the filter element extending in longitudinal axial direction of the filter element, that the tool is then enlarged in at least one subsection of its peripheral surface in an extension running substantially perpendicularly to the longitudinal axial direction of the filter element and is force- and/or form-fittingly connected with an inner lateral surface of the substantially central opening of the filter element, and that the filter element is then pushed by the tool in the longitudinal axial direction, until the filter element projects from the pipeline and is removed from the pipeline.

It is therefore provided that in the method according to the invention, in a first step, a tool is inserted into the central opening of the filter element, which tool is then enlarged in at least one subsection of its peripheral surface. In this manner, the peripheral surface is brought into contact or connected with an inner lateral surface of the central opening of the filter element in a force- and/or form-fitting manner. Subsequently, a sufficiently strong friction force or, in case of a form-fitting connection, a correspondingly strong traction force, can be transmitted by the tool to the filter element, in that the tool together with the filter element is displaced in longitudinal axial direction of the pipeline or the filter element, respectively. A displacement may be accomplished here both in terms of pulling-out or pushing-through of the filter element. As soon as the filter element projects from the pipeline, i.e. when it can be grasped for instance manually, the filter element is removed from the pipeline. Of course there is also the possibility to pull out the filter element completely by means of the tool, so that a manual contact with the filter element can be avoided.

It needs to be explained here that the method according to the invention is not restricted to a round cross-section design of the pipeline or the filter element, respectively. It can of course also be used for filter elements which have a shape deviating from the cylindrical design and are also arranged in a correspondingly differently designed pipeline, even though of course corresponding plants use both hollow cylindrical pipelines and cylindrically designed filter elements.

The term “force-fitting” here means a frictional contact, that means that the peripheral surface of the tool is brought into contact with the inner lateral surface of the central opening of the filter element in such a way that the friction force between the tool and the filter element is sufficient to transmit the traction or compressive force transmitted by the tool to the filter element, so that the filter element can be pulled out against the friction force between the filter element and the inner lateral surface of the pipeline. The term “form-fitting” in this case means that the tool at least partly engages with the filter element and thereby enables a force transmission due to the design of the part of the tool engaging with the filter element. For this purpose, for instance hook elements may be provided which penetrate the filter body.

According to a further development of the method according to the invention, it is provided that the tool is connected with the inner lateral surface of the filter element via at least two clamping elements, wherein the clamping elements are mechanically, hydraulically, and/or pneumatically moved from a first position to a second position increasing the extension of the tool perpendicularly to the longitudinal axial direction of the filter element. In this further development of the method it is therefore provided that the at least two clamping elements, which in this case may for instance be clamping jaws, are pushed out from the surface of the tool and brought into contact with the inner lateral surface of the central opening of the filter element. The displacement of the clamping elements occurs for instance mechanically, in particular via a spindle drive, which will be described further below. There is, however, also the possibility that the clamping elements are moved hydraulically, i.e. with a fluid, or pneumatically, from a first position to a second position, in which the clamping elements project from the surface of the tool in order to achieve an increased extension of the tool and thereby be able to transmit the required friction forces to the filter element. This embodiment has the advantage that the insertion of the tool into the filter element is simplified, and the enlargement of the extension of the tool substantially perpendicularly to the longitudinal axial direction of the filter element can also be carried out in a position where a filter element needs to be uninstalled which is arranged in a central area of a long pipeline and is therefore not manually accessible. Solutions where the clamping elements are moved mechanically, hydraulically or pneumatically are also possible. For instance, a hydraulic or pneumatic drive may be provided for a mechanical spindle mechanism.

According to a further development of the method according to the invention, it is provided that clamping elements with first ends are pivotably articulated to a base body of the tool and that second ends of the clamping elements are moved away from the base body. Preferable is a design of the method according to the invention where the clamping elements are moved via the shortening of the base body of the tool. In this case, both the embodiment described above may be provided, but also one where the clamping elements are displaced in the area of their two ends across inclined surfaces in the base body of the tool in the direction of the inner lateral surface of the filter element.

Finally, according to another feature of the invention, it is provided with respect to the method according to the invention that the enlargement of the extension of the tool substantially perpendicularly to the longitudinal axial direction of the filter element is carried out against a spring element of the tool. This procedure has the advantage that after uninstalling the filter element from the pipeline, the clamping elements are easily moved to the first position, so that the tool can quickly and safely be pulled out of the filter element, i.e. without running the risk of damaging the same. As spring elements, in particular rubber rings can be considered, which surround the base body of the tool in the area of the clamping elements and are tensioned when the clamping elements are moved from the first position to the second position, so that the spring force built up in this process can be used for returning the clamping elements from the second to the first position.

As a solution to the problem according to the invention, it is provided that a tool is formed by a base body, at least one clamping element, and a control device, wherein the clamping element is arranged in the base body movable relative thereto and adjustable between two positions, wherein the clamping element, at least in the second position, enlarges the extension of the base body perpendicularly to its longitudinal axis, and the adjustment of the clamping element to the second position is carried out via the control unit.

The tool according to the invention therefore comprises a base body on which a clamping element movable relative thereto is arranged. The clamping element can be adjusted between two positions, wherein the clamping element, at least in the second position, enlarges the extension of the base body perpendicularly to its longitudinal axis, thereby providing the possibility to increase the required friction force between the tool and the inner lateral surface of the central opening of the filter element. In order to move the clamping element relative to the base body, the control device is provided, by which the clamping element can be moved from the first position to the second position.

The tool according to the invention is further developed in that the base body comprises a spindle and at least two thrust elements as control device which are movable relative to each other in axial direction of the spindle, and at least one clamping element arranged between the thrust elements which, when the thrust elements move toward each other, is displaced radially outward of the base body. With this design, the axial length of the base body is shortened, wherein two thrust elements movable relative to each other are arranged on a spindle. The thrust elements serve as a control device and interact with the clamping element which, by the movement of the thrust elements toward each other, is displaced outwards, thereby resting against the inner lateral surface of the central opening of the filter element. Instead of a spindle, of course also a hydraulic or pneumatic system may be used here, which provides that the thrust elements are moved toward each other by a fluid or by air pressure.

According to another feature of the invention, it is provided that the clamping element consists of two clamping jaws arranged diametrically opposite each other on the base body, or of three or four clamping jaws which are arranged at regular intervals with respect to each other over the circumference of the base body. This design guarantees an even pressure load on the inner lateral surface of the substantially central opening of the filter element, so that on the one hand, an excessive pressure load in a particular surface area is prevented, and on the other hand, the tool remains in the central arrangement within the opening of the filter element.

Another improvement of the tool with respect to friction force transmission to the inner lateral surface of the filter element or with respect to the usability of the tool for longer filter elements, respectively, is achieved in that two or more clamping elements are arranged in-line in axial direction of the base body which are adjustable jointly and unidirectionally via the control device. This ensures that several clamping elements evenly contact the inner lateral surface of the opening of the filter element, and larger areas are available for friction force transmission.

Preferably, the clamping elements in the tool according to the invention are fastened to the base body via resilient retaining elements. These may for instance be resilient rings which surround the tool in the area of the clamping elements and are tensioned when the clamping elements are moved from the first-retracted-position to the second-extended-position, so that the spring force built up in this process can subsequently be used for returning the clamping elements from the second to the first position. This ensures that the clamping elements, also with the corresponding reversed rotation of the spindle, are transferred to the corresponding receptacles of the base body, so that the tool can be pulled out of the filter element without running the risk of damaging the filter element in the area of the inner lateral surface of the opening of the filter element. It is thereby avoided that the clamping elements become entangled in the filter element.

According to another further development of the tool it is provided that the control device can be connected to an extension piece which can be connected to the spindle. Due to this design, the tool can be formed in a relatively compact manner with respect to its length. In order to be nevertheless able to use the tool also for uninstalling filter elements from long pipelines, the extension piece is provided which, depending on the required length of the tool, may also consist of several parts and be assembled like a construction kit.

According to another feature of the invention, it is provided that the base body comprises a stop ring which is arranged on the end of the base body and is formed with an outer contour which protrudes beyond the outer contour of the base body. This stop ring serves to be able to arrange the tool in the appropriate arrangement in the central opening of the filter element, even if this cannot be visually recognised without any problems by the person handling the tool. The stop ring haptically signals the person handling the tool the appropriate position of a sufficiently deeply inserted tool. Furthermore, this ensures that the clamping elements are resting against the positions provided for them inside the filter element. In this manner, it can be avoided that the tool is inserted too deeply into a filter element, so that the clamping elements would then remain without effect for instance when they are moved outside of the filter element from the first to the second position.

The free end of the base body is preferably formed conically in order to facilitate the insertion of the tool into the substantially central opening of the filter element. This is required in particular when the filter element is arranged very far behind the access opening of the pipeline and can therefore not be recognised without difficulty. This design also serves to avoid damages in particular in the front face area of the filter elements.

Moreover, according to a further development of the invention, a centring element is provided which can be connected to the base body or to the extension piece. Such a centring element can be designed as a scissor element and comprise roller elements which roll on the inner surface of the pipeline and thereby guide the tool or an extension piece connected to the tool centrally in the pipeline. Also several centring elements may be provided at regular intervals, wherein the centring elements can preferably be connected to the base body or the extension piece, and consequently also be uninstalled.

Finally, according to another feature of the invention, it is provided that the clamping element can be moved hydraulically or pneumatically.

Other features and advantages of the invention can be gathered from the following description of the associated drawing. In this drawing:

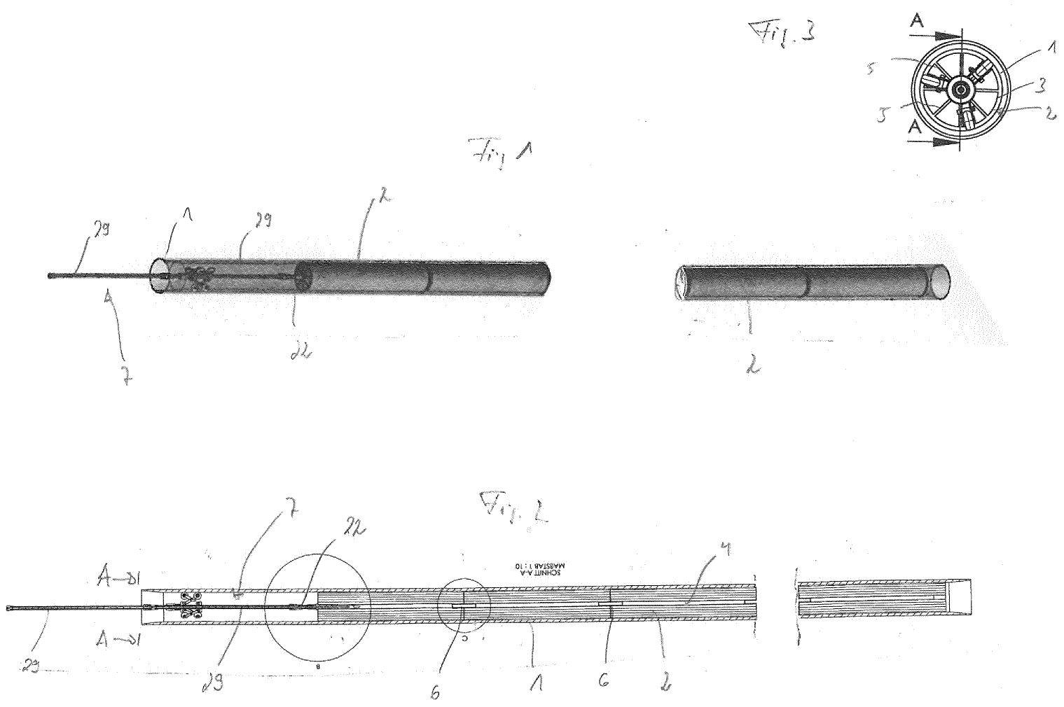

FIG. 1 shows a perspective view of a pipeline with filter elements and a tool for uninstalling the filter elements;

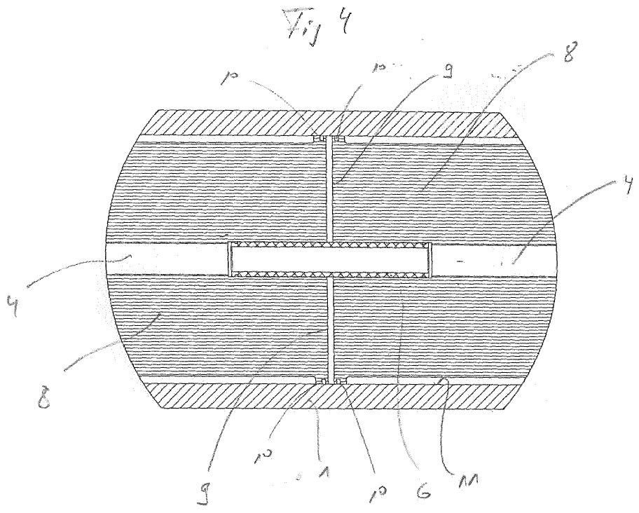

FIG. 2 shows the pipeline according to FIG. 1 represented in a cut side view;

FIG. 3 shows a side view of the pipeline according to FIGS. 1 and 2 along the line A-A in FIG. 2;

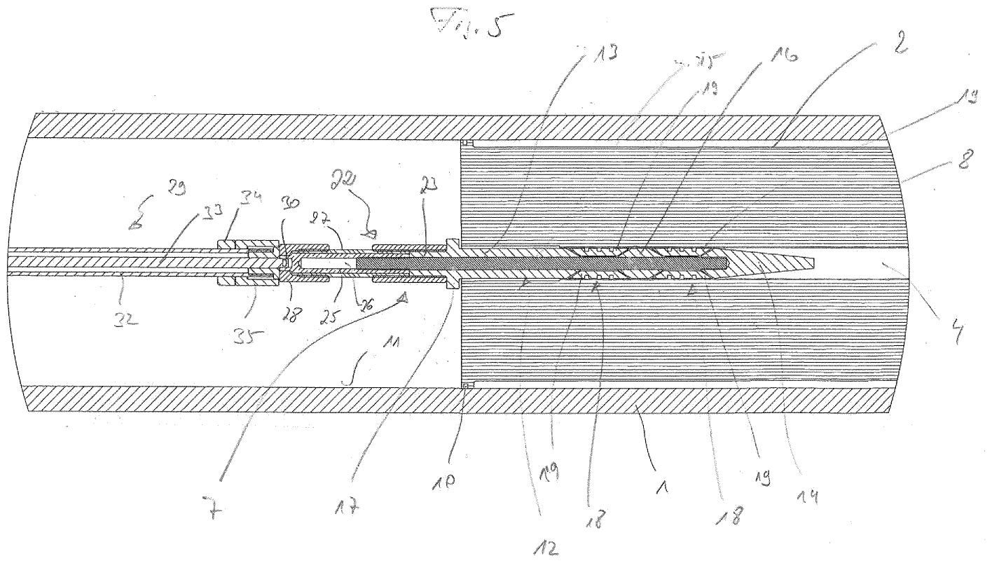

FIG. 4 shows a detailed view of two adjacently arranged filter elements in a pipeline represented in a cut side view;

FIG. 5 shows a detailed view of the tool according to FIG. 1 with a pipeline and a filter element represented in a cut side view;

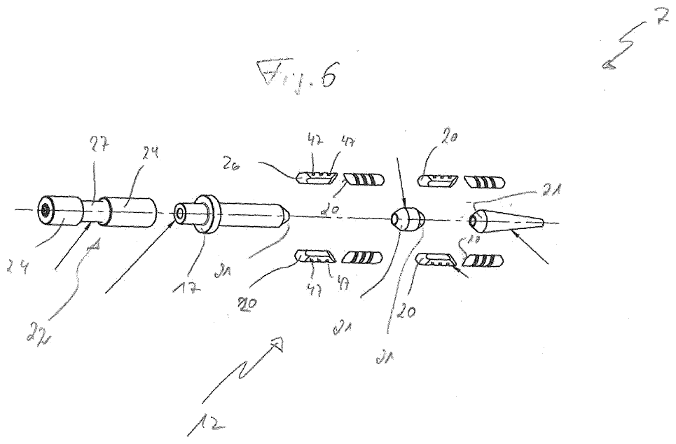

FIG. 6 shows the tool according to FIG. 5 in an exploded view;

FIG. 7 shows a side view of a centring element for the tool according to FIGS. 5 and 6;

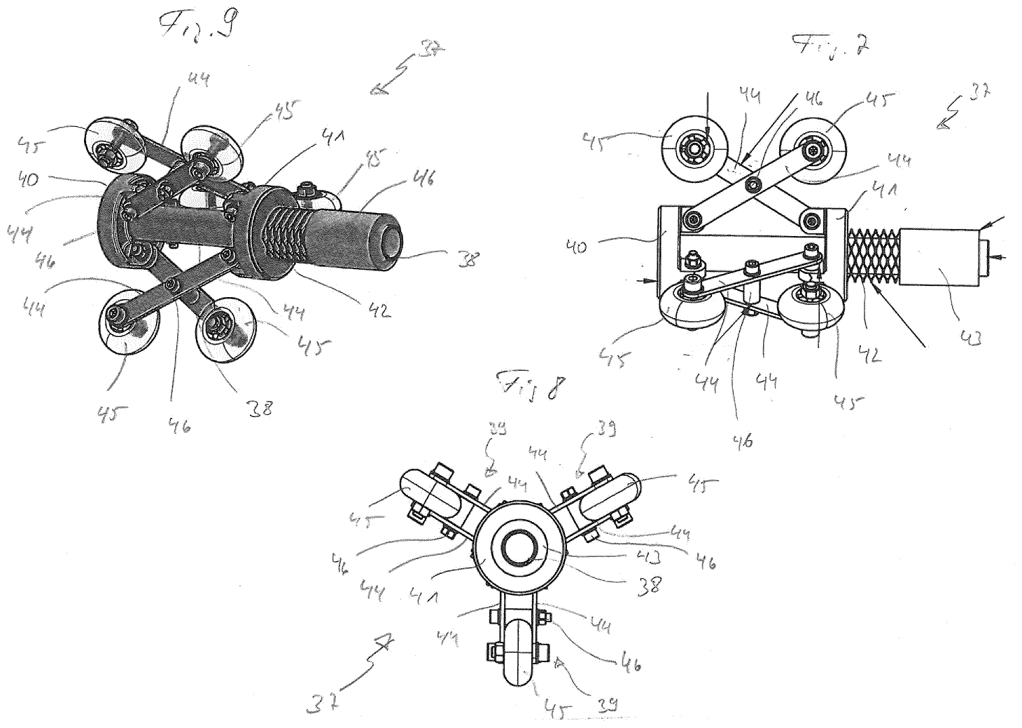

FIG. 8 shows a view of the centring element according to FIG. 7;

FIG. 9 shows a perspective view of the centring element according to FIGS. 7 and 8;

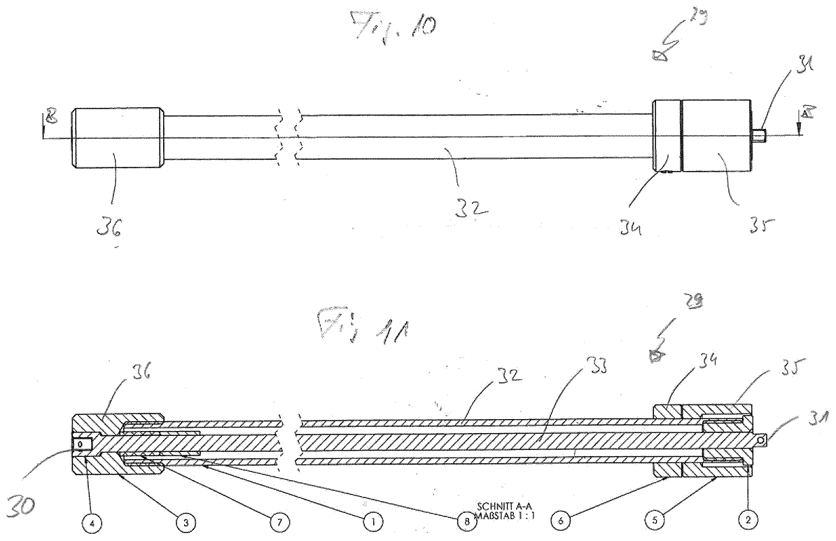

FIG. 10 shows a side view of an extension for the tool;

FIG. 11 shows a cut view of the extension piece according to FIG. 10 along the cutting line B-B in FIG. 10;

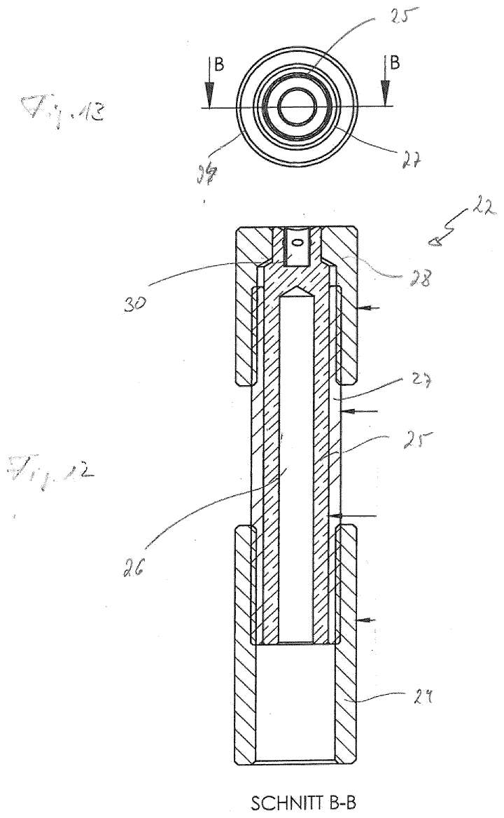

FIG. 12 shows a coupling element for connecting the tool with the extension piece or several elements of the extension piece with each other, respectively, in a cut side view, and

FIG. 13 shows a view of the extension element according to FIG. 12.

The FIGS. 1 through 3 show a pipeline 1 in which a plurality of filter elements 2 are arranged in-line in axial direction. The pipeline 1 has a hollow cylindrical design. The filter elements 2 consist of two ring elements 3 arranged spaced with respect to each other between which a filter body 8, for instance made of a fleece, is arranged. Furthermore, each filter element 2 comprises a central opening 4, which extends through the entire filter element 2 and ends in a ring element not shown in detail, which is connected to the ring element 3 via radially extending webs 5. The external diameter of the ring element 3 substantially corresponds to the internal diameter of pipeline 1, wherein also the filter body 8 has a diameter which approximately corresponds to the internal diameter of pipeline 1. Adjacent filter elements 2 are connected via hollow cylindrical plug-in elements 6.

A pipeline 1 according to the FIGS. 1 through 3 serves, for instance, to osmotically filter an impure medium, e. g. water, in that the medium flows over the outer lateral surface of the filter elements 2 through the filter body 8 and discharges from the pipeline 1 via the central opening 4 of the filter elements 2. In this process, the impurities are removed in an osmosis process by means of the filter body 8.

In the course of this purification process, the filter elements 2 reach a state of saturation with the impurities and must be replaced. In this context, it may be required that a large number of filter elements 2 in a pipeline 1 and, moreover, an even larger number of filter elements 2 in several pipelines 1 running parallel to each other must be replaced. The pipelines 1 have a length which makes it impossible to reach all filter elements 2 by hand in order to pull or push them out of pipeline 1. Therefore, a tool 7 is provided as will be described in the following which serves to connect with a filter element 2 arranged in pipeline 1.

FIG. 4 additionally shows filter body 8 which consists of individual layers of a fleece. Furthermore, it can be seen in FIG. 4 that the filter elements 2 oriented toward each other are connected to each other by a plug-in element 6 and that in addition, the two front faces 9 of each filter element 2 have a diameter which is slightly larger than the diameter of filter body 8, so that the filter elements 2 are formed with a sealing element 10 in this area which rests in a sealing manner against an inner lateral surface 11 of pipeline 1.

In FIG. 5, the tool is shown in detail and is subsequently also described in more detail in relation to FIG. 6. The tool 7 for uninstalling the filter element 2 from the pipeline 1 consists of a base body 12, which consists of two sections 13, 14 movable relative to each other which are arranged on a spindle 15, wherein the base body 12 comprises another central body 16 which is also arranged on the spindle 15, which body can be moved in the direction of section 13 via the spindle 15. In the same manner, section 14 can be moved in the direction of the central body 16 via the spindle 15.

Section 14 is formed conically, so that its diameter tapers toward its free end.

Furthermore, section 13 comprises a stop ring 17 at its end the diameter of which is larger than the diameter of the base body 12, which has an external diameter substantially corresponding to the internal diameter of the central opening 4 of filter element 2.

Arranged between section 14 and section 13 of the base body 12 are two clamping elements 18 consisting of two clamping jaws 19 each the cross-section of which is designed trapezoidally and therefore comprise inclined surfaces 20 which rest against correspondingly formed inclined surfaces 21 on the sections 13, 14 and the body 16. In the first position shown in FIG. 5, the outer surfaces of the clamping jaws 19 are aligned with the external diameter of the sections 13, 14 and the body 16 of the base body 12. By a spindle movement of spindle 15, both the body 16 and section 14 are moved in the direction toward section 13 of base body 12. In this process, the inclined surfaces 20, 21 slide on each other in such a way that due to the shortened distance between the sections 13, 14 and the body 16, the clamping jaws 19 of the clamping elements 18 are displaced outwards and are pressed against the inner lateral surface of the central opening 4, so that a frictional connection is created between the inner lateral surface of the central opening 4 and the outer surfaces of the clamping jaws 19 of the clamping elements 18, which makes it possible to pull the filter element 2 out of pipeline 1 by means of the tool 7. In this process, the frictional force between the clamping jaws 19 of the clamping elements 18 and the inner lateral surface of pipeline 1 must be selected in such a way that it is greater than the frictional force between the outer shell surface of filter element 2 and the inner lateral surface of pipeline 1, in particular in the area of the sealing elements 10. At the same time, it must be ensured that also the plug-in element 6, in case of a pulling movement of tool 7, is pulled out of the adjacent filter element 2, so that in a subsequent working step, the central opening 4 of the adjacent filter element is accessible to tool 7.

The stop ring 17 guarantees here that the tool 7 will be perceptibly arranged appropriately in sufficient depth in the central opening 4 of filter element 2 even if the filter element 2 is not necessarily visually recognisable by the operating person.

The tool 7 according to the FIGS. 5 and 6 additionally comprises the coupling element 22, which is shown in more detail in FIGS. 12 and 13. The coupling element 22 consists of a threaded pipe 24 projecting over a free end 23 of section 13, and a threaded insert 25 which is rotationally moveable therein and comprises a threaded hole 26 for coupling with the spindle 15. Furthermore, another threaded pipe 27 is provided which encloses the threaded insert 25 and is with one end formed on the threaded pipe 24 and with a second end on a threaded bushing 28. The threaded insert 25 is flush with the threaded bushing 28 and has a tool accommodation point in its central area, for instance an opening with a square cross section, to accommodate a correspondingly arranged insert, for instance an extension piece 29, as is shown in FIGS. 10 and 11 and will be described in the following.

The coupling element 22 is placed on the free end 23 of the base body 12 in such a way that the spindle 15 is screwed together with the threaded insert 25, so that the spindle 15 can be twisted in both directions via the threaded insert 25 in order to move the clamping jaws 19 from the first position shown in FIG. 5 to a second position, in which the clamping jaws 19 project from the surface of the base body 12. In this connection, the threaded pipe 24 is flush with the outer surface of the stop ring 17. Into the receptacle 30 on the opposite front face end of the coupling element 22, a projection 31 with a square cross section of the extension piece 29 can be inserted in a form-fitting manner.

The extension piece 29 consists of an external pipe 32 and a rod 33 rotatably arranged therein, which comprises on its two ends correspondingly formed connection elements, namely on the one hand, the projection 31, and on the other hand, a corresponding receptacle 30. On its end in the area of the projection 31, the external pipe 32 is provided with an adjustment ring 34 arranged on the external pipe and a sleeve nut 35, while on the opposite end, the external pipe 32 is provided with a bushing 36 with a shoulder. In the bushing 36, the receptacle 30 is arranged, into which the projection 31 of another extension piece 29 or a tool, as for instance a ratchet, can be inserted. For this purpose, the rod 33 is mounted in a rotatable manner relative to the external pipe 32.

With very great lengths of the tool 7, for instance by using several extension pieces 29, a centring means 37 shown in FIGS. 7 through 9 can be fastened to the tool. The centring means 37 consists of a central pipe 38, which serves to accommodate an extension piece 29 and which comprises guide elements 39 at regular equidistant intervals. The pipe 38 comprises a flange 40, furthermore the pipe 38 comprises a guide element 41 displaceable in axial direction relative to the flange 40, which guide element 41 in turn is supported by a threaded bushing 43, wherein the guide element 41 and also the threaded bushing 43 enclose the pipe 38 and are displaceable relative to its longitudinal axis direction.

In the area of collar surfaces of the flange 40 and the guide element 41 which collar surfaces are oriented toward each other, lever arms 44 are arranged pivotably, on the free ends of which rolling bodies 45 are mounted in a rotatable manner. These may be rubber-tyred rims.

Two lever arms 44 each are connected with each other via an axis 46, wherein the axis 46 in combination with the flange 40 and the guide element 41 enables a scissors-like movement of the lever arms 44. By adjusting the threaded bushing 43, the rolling bodies 45 are adjusted at a predetermined distance to the pipe 38, wherein a setting is selected where the rolling bodies 45 roll on the inner wall surface of pipeline 1, thereby guiding the centring means 37 in the central area of pipeline 1. Any unevennesses in the area of the inner lateral surface of pipeline 1 can thereby be evened out via the spring washer 42.

By means of the tool 7 described above, filter elements 2 can be uninstalled from a pipeline 1 in a material-protective way. For this purpose, the base body 12 with clamping jaws 19 positioned in the first position according to FIG. 5 is inserted into the central opening 4 of the filter element 2, until the stop ring 17 rests against the front face of the filter element 2 to be uninstalled. Via the coupling element 22 and an extension piece 29 connected thereto, the sections 13, 14 and the body 16 of the base body 12 are then spindled toward each other, so that the clamping jaws 19 are pushed out of the surface of the base body 12 and are brought to rest against the inner lateral surface of the central opening 4 of the filter element 2. Subsequently, the filter element 2 can be pulled out of the pipeline 1 in axial direction of this pipeline 1, wherein the plug-in element 6 is ripped out of the adjacent filter element 2. Both the movement of the tool 7 in the direction of the filter element 2 to be uninstalled from pipeline 1 and the pulling-out of the filter element 2 from pipeline 1 are supported by the centring means 37, which is arranged on the outside pipe 32 of the extension piece 29 and rolls on the inner lateral surface of pipeline 1 with the rolling bodies 45.

In addition to the embodiment of a tool 7 described above, also other variations are possible. Accordingly, it is not mandatory that the clamping jaws 19 of the clamping elements 18 are moved via a spindle, and that the associated relative movement of the sections 13, 14 and of the body 16 is performed in the direction of the spindle 15 and towards each other. An embodiment is rather also imaginable where the clamping jaws 19 of the clamping elements 18 can be adjusted hydraulically or pneumatically. Here, it can for instance be provided that within the base body 12, instead of the spindle 15, linear motors are provided which are driven pneumatically or hydraulically, and that the clamping jaws 19 are pushed out via the application of pressure on the linear motors.

Both in this embodiment and in the embodiment with the spindle 15 described before, the reset can be done via spring elements not shown in detail, for instance rubber rings, which are arranged in annular grooves 47 of the clamping jaws 19, wherein in the exemplary embodiment according to the FIGS. 5 and 6, each clamping jaw 19 comprises three parallel annular grooves which serve to accommodate rubber rings which are not shown in detail. When the clamping jaws 19 are displaced from a first position shown in FIG. 5 to a second position not shown in detail, where the clamping jaws 19 rest frictionally against the inner wall surface of the central opening 4 of the filter element 2, these rubber rings are tensioned, so that with spindling back, and thereby a return of the clamping jaws 19 to the first position shown in FIG. 5, the resetting of the clamping jaws 19 is supported by the rubber rings.

1. Method for uninstalling a filter element from a pipeline, said filter element having a substantially central opening and an outer contour that substantially corresponds to an inner contour of said pipeline, where a tool in a first position is inserted into the substantially central opening of the filter element extending in longitudinal axial direction of the filter element, the tool is subsequently transferred in at least one subsection of its peripheral surface to a second position with an enlarged extension running substantially perpendicularly to the longitudinal axial direction of the filter element, and the tool is force- and/or form-fittingly connected to an inner lateral surface of the substantially central opening of the filter element, said filter element finally being pushed with the tool in longitudinal axial direction until the filter element projects out of the pipeline and is removed from the pipeline, wherein the enlargement of the extension of the tool is carried out substantially perpendicularly to the longitudinal axial direction of the filter element against a spring element of the tool, so that after dismounting of the filter element from the pipeline, the tool is transferred from the second to the first position.

2. Method according to claim 1, characterised in that the tool is connected to the inner lateral surface of the filter element by at least two clamping elements, wherein the clamping elements are transferred mechanically, hydraulically and/or pneumatically from a first position to a second position enlarging the extension of the tool perpendicularly to the longitudinal axial direction of the filter element.

3. Method according to claim 2, characterised in that first ends of the clamping elements are pivotably articulated to a base body of the tool, and that second ends of the clamping elements are moved away from the base body.

4. Tool for uninstalling a filter element from a pipeline, wherein the filter element comprises a particularly central opening and an outer contour which substantially corresponds to an inner contour of the pipeline, in particular for carrying out the method according to one of the claims 1 through 3, consisting of a base body, at least one clamping element which is arranged in the base body and movable relative thereto and adjustable between a first and a second position, wherein the clamping element, at least in the second position, enlarges the extension of the base body perpendicularly to its longitudinal axis, until the clamping element is force- or form-fittingly connected to an inner lateral surface of the filter element, and a control device for adjusting the clamping element to the second position, characterised in that a spring element is provided against which the enlargement of the extension of the base body can be carried out and which transfers the base body from the second position to the first position after uninstalling the filter element from the pipeline.

5. Tool according to claim 4, characterised in that the base body comprises a spindle and at least two thrust elements movable relative to each other in axial direction of the spindle as control device and at least one clamping element arranged between the thrust elements, which clamping element is pushed radially outward of the base body upon a movement of the thrust elements toward each other.

6. Tool according to claim 4 or 5, characterised in that the clamping element consists of two clamping jaws arranged diametrically opposite each other on the base body, or of three or four clamping jaws which are arranged on the base body at regular intervals with respect to each other.

7. Tool according to one of the claims 4 through 6, characterised in that two or more clamping elements are arranged in-line in axial direction of the base body and are adjustable jointly and unidirectionally by the control device.

8. Tool according to one of the claims 4 through 7, characterised in that the clamping elements are fastened to the base body via resilient retaining elements.

9. Tool according to one of the claims 5 through 8, characterised in that the control device can be connected to an extension piece which can be connected to the spindle.

10. Tool according to one of the claims 4 through 9, characterised in that the base body comprises a stop ring arranged on the end of the base body and designed with an outer contour which protrudes beyond the outer contour of the base body.

11. Tool according to one of the claims 4 through 10, characterised in that the free end of the base body is formed conically.

12. Tool according to one of the claims 4 through 11, characterised in that a centring element is provided which can be connected to the base body or to the extension piece.

13. Tool according to one of the claims 4 through 12, characterised in that the clamping element can be moved hydraulically or pneumatically.
